(19) United States
(12) Patent Application Publication
(10) Pub. No.: US 2018/0152944 A1
(43) Pub. Date: May 31, 2018

(54) TECHNIQUES AND APPARATUSES FOR IMPROVING CARRIER AGGREGATION THROUGHPUT IN A FEEDBACK RECEIVER BASED DEVICE

(71) Applicant: QUALCOMM Incorporated, San Diego, CA (US)

(72) Inventors: Akash KUMAR, Hyderabad (IN); Ankit Ashok Agarwal, San Jose, CA (US); Ankit Maheshwari, Hyderabad (IN); Atul Soni, Hyderabad (IN)

(21) Appl. No.: 15/364,832

(22) Filed: Nov. 30, 2016

(51) Int. Cl. H04W 72/04; H04W 24/08; H04L 12/26; H04W 24/10; H04W 72/08

(52) U.S. Cl. CPC H04W 72/0453; H04W 24/08; H04W 72/085; H04W 24/10; H04L 43/0888

(57) ABSTRACT

Certain aspects of the present disclosure generally relate to wireless communications. In some aspects, a wireless communication device may determine that a first component carrier (CC), associated with a first communications chain of one or more components of the wireless communication device, has a lower throughput than a second CC associated with a second communications chain of the one or more components, wherein the second communications chain selectively receives a signal of a feedback receiver of a component of the one or more components. The wireless communication device may configure the one or more components of the wireless communication device to receive first communications of the first CC on the second communications chain and to receive second communications of the second CC on the first communications chain based at least in part on determining that the first CC has a lower throughput than the second CC.

### FIELD OF THE DISCLOSURE

Aspects of the present disclosure generally relate to wireless communications, and more particularly to techniques and apparatuses for improving carrier aggregation throughput in a feedback receiver based device.

### BACKGROUND

Wireless communications systems are widely deployed to provide various telecommunication services, such as telephony, video, data, messaging, and broadcasts. Typical wireless communications systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, using new spectrum, and integrating with other open standards using OFDMA on the downlink (DL), SC-FDMA on the uplink (UL), and multiple-input multiple-output (MIMO) antenna technology.

### SUMMARY

In some aspects, a method for wireless communications may include determining that a first component carrier (CC), associated with a first communications chain of one or more components of a wireless communication device, has a lower throughput than a second CC associated with a second communications chain of the one or more components of the wireless communication device, wherein the second communications chain selectively receives a signal of a feedback receiver of a component of the one or more components of the wireless communication device. The method may include configuring the one or more components of the wireless communication device to receive first communications of the first CC on the second communications chain and to receive second communications of the second CC on the first communications chain based at least in part on determining that the first CC has a lower throughput than the second CC.

In some aspects, a wireless communication device for wireless communications may include one or more processors configured to determine that a first component carrier (CC), associated with a first communications chain of one or more components of the wireless communication device, has a lower throughput than a second CC associated with a second communications chain of the one or more components of the wireless communication device, wherein the second communications chain selectively receives a signal of a feedback receiver of a component of the one or more components of the wireless communication device. The one or more processors may be configured to configure the one or more components of the wireless communication device to receive first communications of the first CC on the second communications chain and to receive second communications of the second CC on the first communications chain based at least in part on determining that the first CC has a lower throughput than the second CC.

In some aspects, an apparatus for wireless communications may include means for determining that a first component carrier (CC), associated with a first communications chain of one or more components of the apparatus, has a lower throughput than a second CC associated with a second communications chain of the one or more components of the apparatus, wherein the second communications chain selectively receives a signal of a feedback receiver of a component of the one or more components of the apparatus. The apparatus may include means for configuring the one or more components of the apparatus to receive first communications of the first CC on the second communications chain and to receive second communications of the second CC on the first communications chain based at least in part on determining that the first CC has a lower throughput than the second CC.

Aspects generally include a method, apparatus, system, computer program product, non-transitory computer-readable medium, user equipment, wireless communication device, and processing system as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example deployment in which multiple wireless networks have overlapping coverage, in accordance with various aspects of the present disclosure.

FIG. 2 is a diagram illustrating an example access network in an LTE network architecture, in accordance with various aspects of the present disclosure.

FIG. 3 is a diagram illustrating an example of a downlink frame structure in LTE, in accordance with various aspects of the present disclosure.

FIG. 4 is a diagram illustrating an example of an uplink frame structure in LTE, in accordance with various aspects of the present disclosure.

FIG. 5 is a diagram illustrating an example of a radio protocol architecture for a user plane and a control plane in LTE, in accordance with various aspects of the present disclosure.

FIG. 6 is a diagram illustrating example components of an evolved Node B and a user equipment in an access network, in accordance with various aspects of the present disclosure.

FIGS. 7A and 7B are diagrams illustrating example LTE carrier aggregation types, in accordance with various aspects of the present disclosure.

FIG. 8A is a diagram illustrating example components of a wireless communication device.

FIGS. 8B-8C are diagrams illustrating example components of a wireless communication device, in accordance with various aspects of the present disclosure.

FIGS. 9A and 9B are diagrams illustrating an example of performing configuration of component carriers to improve carrier aggregation throughput in a feedback receiver based wireless communication device, in accordance with various aspects of the present disclosure.

FIGS. 10A-10C are diagrams illustrating another example of performing configuration of component carriers to improve carrier aggregation throughput in a feedback receiver based wireless communication device, in accordance with various aspects of the present disclosure.

FIG. 11 is a diagram illustrating an example process performed, for example, by a wireless communication device, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

The techniques described herein may be used for one or more of various wireless communications networks such as code division multiple access (CDMA) networks, time division multiple access (TDMA) networks, frequency division multiple access (FDMA) networks, orthogonal FDMA (OFDMA) networks, single carrier FDMA (SC-FDMA) networks, or other types of networks. A CDMA network may implement a radio access technology (RAT) such as universal terrestrial radio access (UTRA), CDMA2000, and/or the like. UTRA may include wideband CDMA (WCDMA) and/or other variants of CDMA. CDMA2000 may include Interim Standard (IS)-2000, IS-95 and IS-856 standards. IS-2000 may also be referred to as 1× radio transmission technology (1×RTT), CDMA2000 1×, and/or the like. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), Institute of Electrical and Electronics Engineers (IEEE) 802.11 (Wi-Fi), IEEE 802.16 (WiMAX), IEEE 802.20, Flash-OFDM, and/or the like. UTRA and E-UTRA may be part of the universal mobile telecommunication system (UMTS). 3GPP long-term evolution (LTE) and LTE-Advanced (LTE-A) are example releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and RATs mentioned above as well as other wireless networks and RATs.

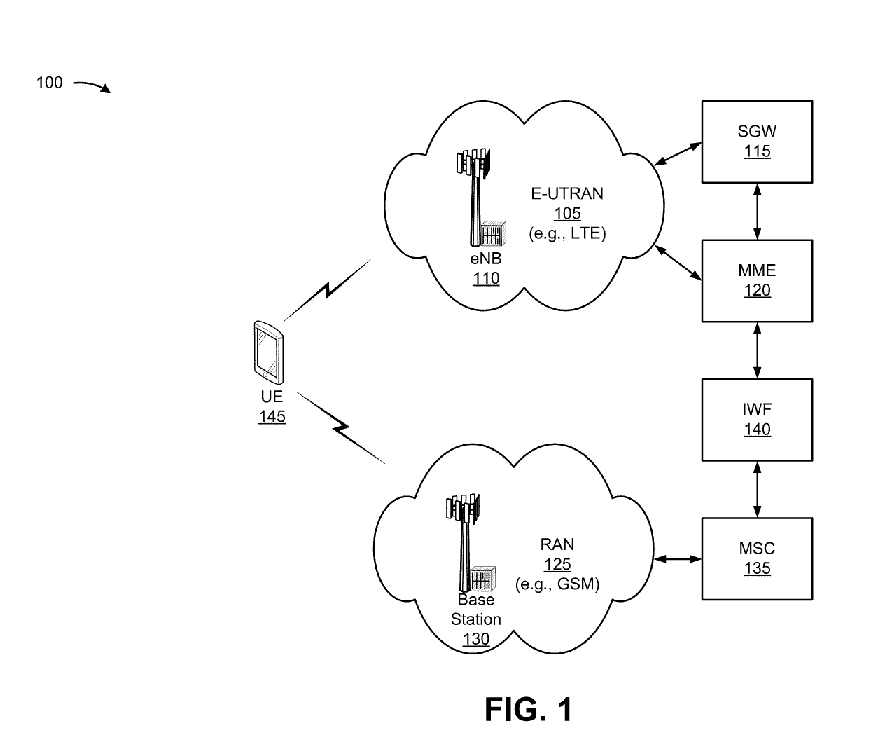

FIG. 1 is a diagram illustrating an example deployment 100 in which multiple wireless networks have overlapping coverage, in accordance with various aspects of the present disclosure. As shown, example deployment 100 may include an evolved universal terrestrial radio access network (E-UTRAN) 105, which may include one or more evolved Node Bs (eNBs) 110, and which may communicate with other devices or networks via a serving gateway (SGW) 115 and/or a mobility management entity (MME) 120. As further shown, example deployment 100 may include a radio access network (RAN) 125, which may include one or more base stations 130, and which may communicate with other devices or networks via a mobile switching center (MSC) 135 and/or an inter-working function (IWF) 140. As further shown, example deployment 100 may include one or more user equipment (UEs) 145 capable of communicating via E-UTRAN 105 and/or RAN 125.

E-UTRAN 105 may support, for example, LTE or another type of RAT. E-UTRAN 105 may include eNBs 110 and other network entities that can support wireless communications for UEs 145. Each eNB 110 may provide communication coverage for a particular geographic area. The term “cell” may refer to a coverage area of eNB 110 and/or an eNB subsystem serving the coverage area.

SGW 115 may communicate with E-UTRAN 105 and may perform various functions, such as packet routing and forwarding, mobility anchoring, packet buffering, initiation of network-triggered services, and/or the like. MME 120 may communicate with E-UTRAN 105 and SGW 115 and may perform various functions, such as mobility management, bearer management, distribution of paging messages, security control, authentication, gateway selection, and/or the like, for UEs 145 located within a geographic region served by MME 120 of E-UTRAN 105. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

RAN 125 may support, for example, GSM or another type of RAT. RAN 125 may include base stations 130 and other network entities that can support wireless communications for UEs 145. MSC 135 may communicate with RAN 125 and may perform various functions, such as voice services, routing for circuit-switched calls, and mobility management for UEs 145 located within a geographic region served by MSC 135 of RAN 125. In some aspects, IWF 140 may facilitate communication between MME 120 and MSC 135 (e.g., when E-UTRAN 105 and RAN 125 use different RATs). Additionally, or alternatively, MME 120 may communicate directly with an MME that interfaces with RAN 125, for example, without IWF 140 (e.g., when E-UTRAN 105 and RAN 125 use a same RAT). In some aspects, E-UTRAN 105 and RAN 125 may use the same frequency and/or the same RAT to communicate with UE 145. In some aspects, E-UTRAN 105 and RAN 125 may use different frequencies and/or RATs to communicate with UEs 145.

In general, any number of wireless networks may be deployed in a given geographic area. Each wireless network may support a particular RAT and may operate on one or more frequencies. A RAT may also be referred to as a radio technology, an air interface, and/or the like. A frequency or frequency ranges may also be referred to as a carrier, a frequency channel, and/or the like. Each frequency or frequency range may support a single RAT in a given geographic area in order to avoid interference between wireless networks of different RATs.

UE 145 may be stationary or mobile and may also be referred to as a mobile station, a terminal, an access terminal, a wireless communication device, a subscriber unit, a station, and/or the like. UE 145 may be a cellular phone, a personal digital assistant (PDA), a wireless modem, a wireless communication device, a handheld device, a laptop computer, a cordless phone, a wireless local loop (WLL) station, and/or the like.

Upon power up, UE 145 may search for wireless networks from which UE 145 can receive communication services. If UE 145 detects more than one wireless network, then a wireless network with the highest priority may be selected to serve UE 145 and may be referred to as the serving network. UE 145 may perform registration with the serving network, if necessary. UE 145 may then operate in a connected mode to actively communicate with the serving network. Alternatively, UE 145 may operate in an idle mode and camp on the serving network if active communication is not required by UE 145.

UE 145 may operate in the idle mode as follows. UE 145 may identify all frequencies/RATs on which it is able to find a “suitable” cell in a normal scenario or an “acceptable” cell in an emergency scenario, where “suitable” and “acceptable” are specified in the LTE standards. UE 145 may then camp on the frequency/RAT with the highest priority among all identified frequencies/RATs. UE 145 may remain camped on this frequency/RAT until either (i) the frequency/RAT is no longer available at a predetermined threshold or (ii) another frequency/RAT with a higher priority reaches this threshold. In some aspects, UE 145 may receive a neighbor list when operating in the idle mode, such as a neighbor list included in a system information block type 5 (SIB 5) provided by an eNB of a RAT on which UE 145 is camped. Additionally, or alternatively, UE 145 may generate a neighbor list. A neighbor list may include information identifying one or more frequencies, at which one or more RATs may be accessed, priority information associated with the one or more RATs, and/or the like.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

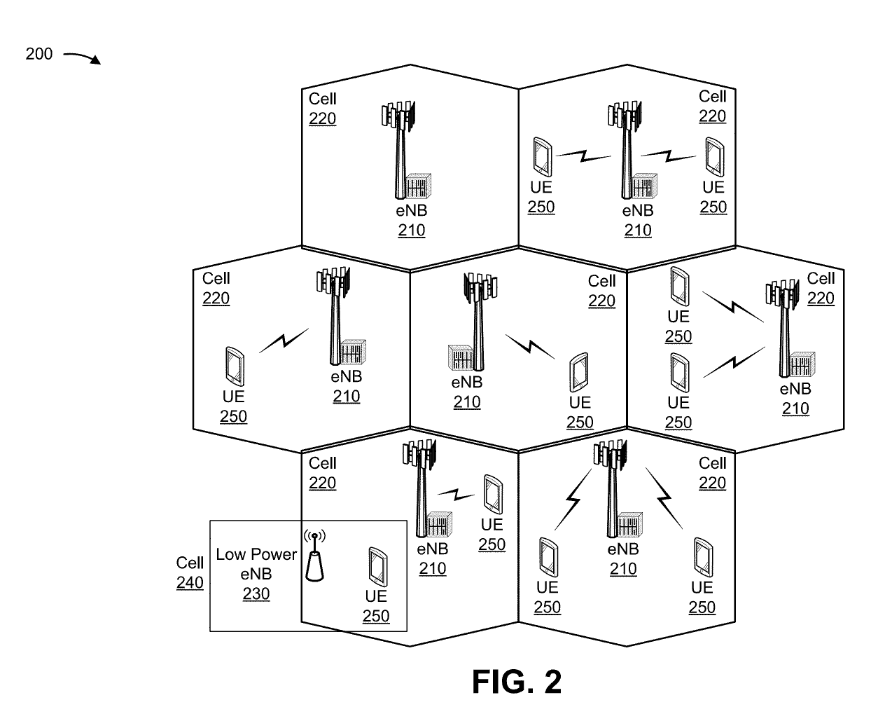

FIG. 2 is a diagram illustrating an example access network 200 in an LTE network architecture, in accordance with various aspects of the present disclosure. As shown, access network 200 may include one or more eNBs 210 that serve a corresponding set of cellular regions (cells) 220, one or more low power eNBs 230 that serve a corresponding set of cells 240, and a set of UEs 250.

Each eNB 210 may be assigned to a respective cell 220 and may be configured to provide an access point to a RAN. For example, eNB 110, 210 may provide an access point for UE 145, 250 to E-UTRAN 105 (e.g., eNB 210 may correspond to eNB 110, shown in FIG. 1) or may provide an access point for UE 145, 250 to RAN 125 (e.g., eNB 210 may correspond to base station 130, shown in FIG. 1). UE 145, 250 may correspond to UE 145, shown in FIG. 1. FIG. 2 does not illustrate a centralized controller for example access network 200, but access network 200 may use a centralized controller in some aspects. The eNBs 210 may perform radio related functions including radio bearer control, admission control, mobility control, scheduling, security, and network connectivity (e.g., to SGW 115).

As shown in FIG. 2, one or more low power eNBs 230 may serve respective cells 240, which may overlap with one or more cells 220 served by eNBs 210. The eNBs 230 may correspond to eNB 110 associated with E-UTRAN 105 and/or base station 130 associated with RAN 125, shown in FIG. 1. A low power eNB 230 may be referred to as a remote radio head (RRH). The low power eNB 230 may include a femto cell eNB (e.g., home eNB (HeNB)), a pico cell eNB, a micro cell eNB, and/or the like.

A modulation and multiple access scheme employed by access network 200 may vary depending on the particular telecommunications standard being deployed. In LTE applications, OFDM is used on the downlink (DL) and SC-FDMA is used on the uplink (UL) to support both frequency division duplexing (FDD) and time division duplexing (TDD). The various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. As another example, these concepts may also be extended to UTRA employing WCDMA and other variants of CDMA (e.g., such as TD-SCDMA, GSM employing TDMA, E-UTRA, and/or the like), UMB, IEEE 802.11 (Wi-Fi), IEEE 802.16 (WiMAX), IEEE 802.20, Flash-OFDM employing OFDMA, and/or the like. UTRA, E-UTRA, UMTS, LTE and GSM are described in documents from the 3GPP organization. CDMA2000 and UMB are described in documents from the 3GPP2 organization. The actual wireless communications standard and the multiple access technology employed will depend on the specific application and the overall design constraints imposed on the system.

The eNBs 210 may have multiple antennas supporting MIMO technology. The use of MIMO technology enables eNBs 210 to exploit the spatial domain to support spatial multiplexing, beamforming, and transmit diversity. Spatial multiplexing may be used to transmit different streams of data simultaneously on the same frequency. The data streams may be transmitted to a single UE 145, 250 to increase the data rate or to multiple UEs 250 to increase the overall system capacity. This may be achieved by spatially precoding each data stream (e.g., applying a scaling of an amplitude and a phase) and then transmitting each spatially precoded stream through multiple transmit antennas on the DL. The spatially precoded data streams arrive at the UE(s) 250 with different spatial signatures, which enables each of the UE(s) 250 to recover the one or more data streams destined for that UE 145, 250. On the UL, each UE 145, 250 transmits a spatially precoded data stream, which enables eNBs 210 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

The number and arrangement of devices and cells shown in FIG. 2 are provided as an example. In practice, there may be additional devices and/or cells, fewer devices and/or cells, different devices and/or cells, or differently arranged devices and/or cells than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

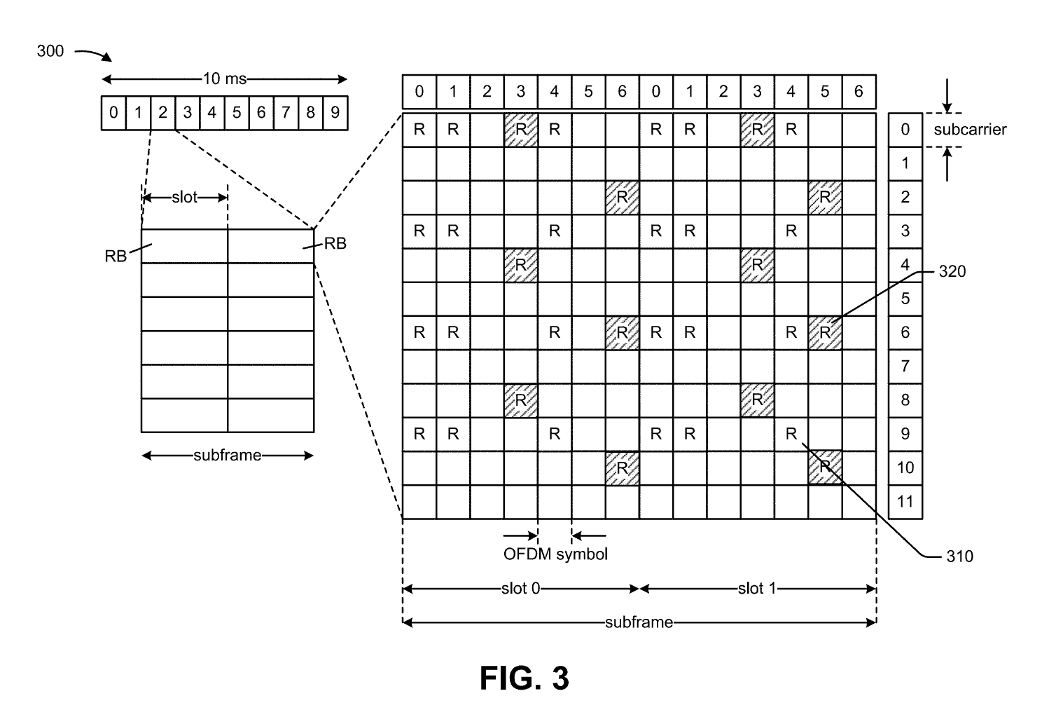

FIG. 3 is a diagram illustrating an example 300 of a downlink (DL) frame structure in LTE, in accordance with various aspects of the present disclosure. A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the LTE in any of the combinations that the UE will search.

As indicated above, FIG. 3 is provided as an example. Other examples are possible and may differ from what was described above in connection with FIG. 3.

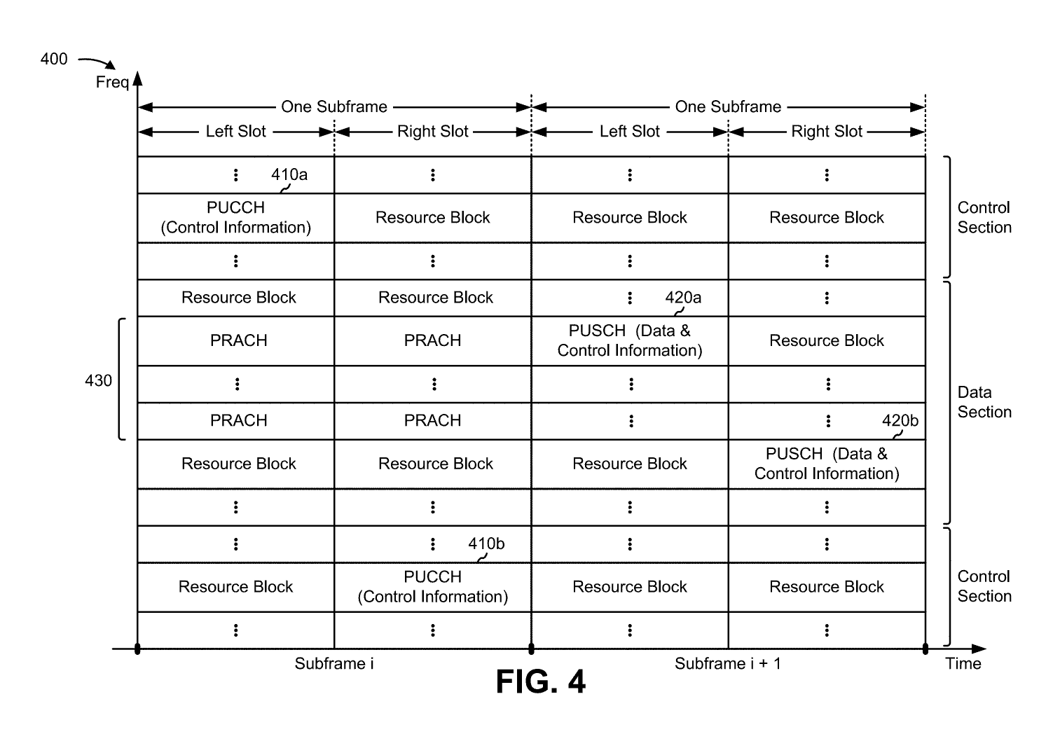

FIG. 4 is a diagram illustrating an example 400 of an uplink (UL) frame structure in LTE, in accordance with various aspects of the present disclosure. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms).

As indicated above, FIG. 4 is provided as an example. Other examples are possible and may differ from what was described above in connection with FIG. 4.

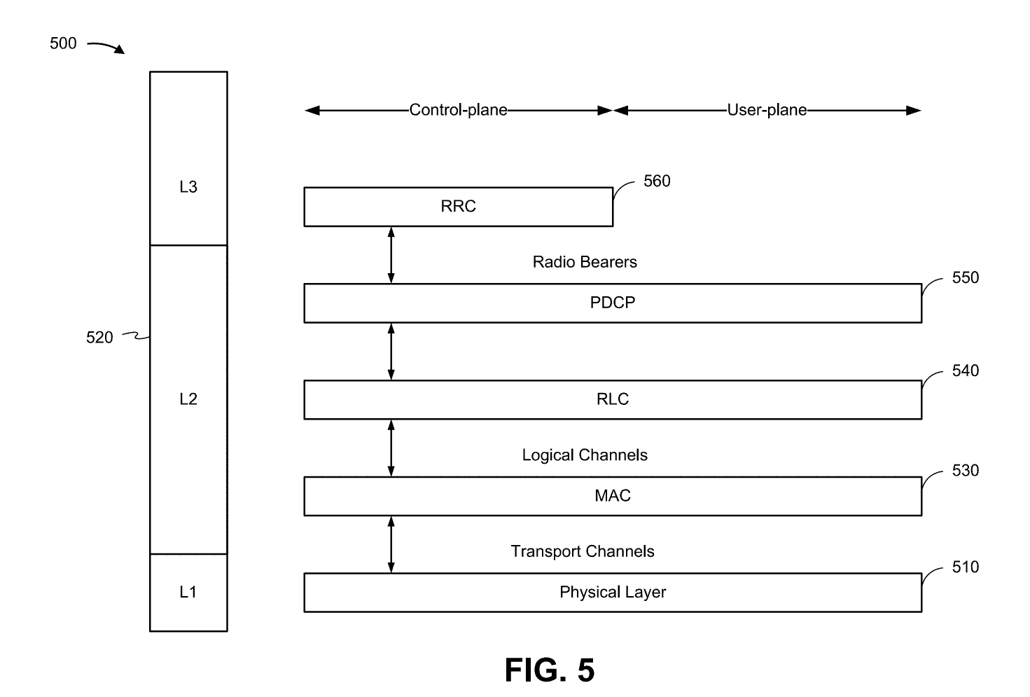

FIG. 5 is a diagram illustrating an example 500 of a radio protocol architecture for a user plane and a control plane in LTE, in accordance with various aspects of the present disclosure. The radio protocol architecture for the UE (e.g., UE 145, 250) and the eNB (e.g., eNB 110, 210, 230) is shown with three layers: Layer 1, Layer 2, and Layer 3. Layer 1 (L1 layer) is the lowest layer and implements various physical layer signal processing functions. The L1 layer will be referred to herein as the physical layer 510. Layer 2 (L2 layer) 520 is above the physical layer 510 and is responsible for the link between the UE and eNB over the physical layer 510.

In the user plane, the L2 layer 520 includes, for example, a media access control (MAC) sublayer 530, a radio link control (RLC) sublayer 540, and a packet data convergence protocol (PDCP) sublayer 550, which are terminated at the eNB on the network side. Although not shown, the UE may have several upper layers above the L2 layer 520 including a network layer (e.g., IP layer) that is terminated at a packet data network (PDN) gateway on the network side, and an application layer that is terminated at the other end of the connection (e.g., far end UE, server, and/or the like).

The PDCP sublayer 550 provides multiplexing between different radio bearers and logical channels. The PDCP sublayer 550 also provides header compression for upper layer data packets to reduce radio transmission overhead, security by ciphering the data packets, and handover support for UEs between eNBs. The RLC sublayer 540 provides segmentation and reassembly of upper layer data packets, retransmission of lost data packets, and reordering of data packets to compensate for out-of-order reception due to hybrid automatic repeat request (HARQ). The MAC sublayer 530 provides multiplexing between logical and transport channels. The MAC sublayer 530 is also responsible for allocating the various radio resources (e.g., resource blocks) in one cell among the UEs. The MAC sublayer 530 is also responsible for HARQ operations.

In the control plane, the radio protocol architecture for the UE and eNB is substantially the same for the physical layer 510 and the L2 layer 520 with the exception that there is no header compression function for the control plane. The control plane also includes a radio resource control (RRC) sublayer 560 in Layer 3 (L3 layer). The RRC sublayer 560 is responsible for obtaining radio resources (i.e., radio bearers) and for configuring the lower layers using RRC signaling between the eNB and the UE.

As indicated above, FIG. 5 is provided as an example. Other examples are possible and may differ from what was described above in connection with FIG. 5.

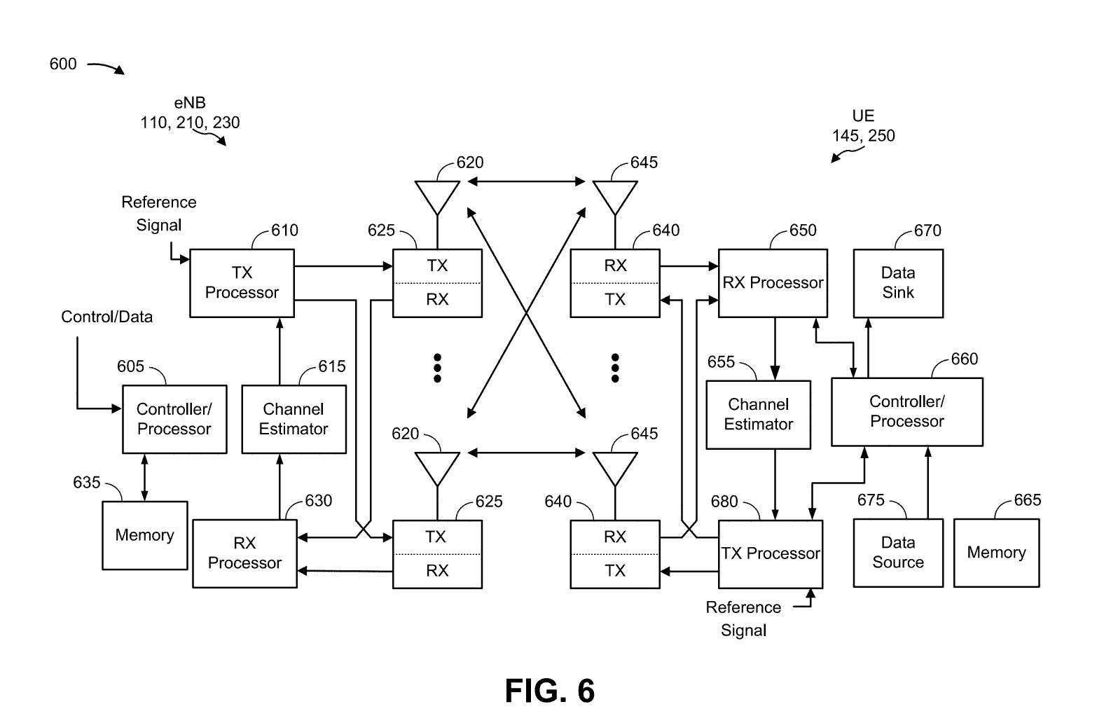

FIG. 6 is a diagram illustrating example components 600 of eNB 110, 210, 230 and UE 145, 250 in an access network, in accordance with various aspects of the present disclosure. As shown in FIG. 6, eNB 110, 210, 230 may include a controller/processor 605, a TX processor 610, a channel estimator 615, an antenna 620, a transmitter 625TX, a receiver 625RX, an RX processor 630, and a memory 635. As further shown in FIG. 6, UE 145, 250 may include a receiver RX, for example, of a transceiver TX/RX 640, a transmitter TX, for example, of a transceiver TX/RX 640, an antenna 645, an RX processor 650, a channel estimator 655, a controller/processor 660, a memory 665, a data sink 670, a data source 675, and a TX processor 680.

In the DL, upper layer packets from the core network are provided to controller/processor 605. The controller/processor 605 implements the functionality of the L2 layer. In the DL, the controller/processor 605 provides header compression, ciphering, packet segmentation and reordering, multiplexing between logical and transport channels, and radio resource allocations to the UE 145, 250 based, at least in part, on various priority metrics. The controller/processor 605 is also responsible for HARQ operations, retransmission of lost packets, and signaling to the UE 145, 250.

The TX processor 610 implements various signal processing functions for the L1 layer (e.g., physical layer). The signal processing functions includes coding and interleaving to facilitate forward error correction (FEC) at the UE 145, 250 and mapping to signal constellations based, at least in part, on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 615 may be used to determine the coding and modulation scheme, as well as for spatial processing. The channel estimate may be derived from a reference signal and/or channel condition feedback transmitted by the UE 145, 250. Each spatial stream is then provided to a different antenna 620 via a separate transmitter TX, for example, of transceiver TX/RX 625. Each such transmitter TX modulates an RF carrier with a respective spatial stream for transmission.

At the UE 145, 250, each receiver RX, for example, of a transceiver TX/RX 640 receives a signal through its respective antenna 645. Each such receiver RX recovers information modulated onto an RF carrier and provides the information to the receiver (RX) processor 650. The RX processor 650 implements various signal processing functions of the L1 layer. The RX processor 650 performs spatial processing on the information to recover any spatial streams destined for the UE 145, 250. If multiple spatial streams are destined for the UE 145, 250, the spatial streams may be combined by the RX processor 650 into a single OFDM symbol stream. The RX processor 650 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 110, 210, 230. These soft decisions may be based, at least in part, on channel estimates computed by the channel estimator 655. The soft decisions are then decoded and deinterleaved to recover the data and control signals that were originally transmitted by the eNB 110, 210, 230 on the physical channel. The data and control signals are then provided to the controller/processor 660.

The controller/processor 660 implements the L2 layer. The controller/processor 660 can be associated with a memory 665 that stores program codes and data. The memory 665 may include a non-transitory computer-readable medium. In the UL, the controller/processor 660 provides demultiplexing between transport and logical channels, packet reassembly, deciphering, header decompression, control signal processing to recover upper layer packets from the core network. The upper layer packets are then provided to a data sink 670, which represents all the protocol layers above the L2 layer. Various control signals may also be provided to the data sink 670 for L3 processing. The controller/processor 660 is also responsible for error detection using an acknowledgement (ACK) and/or negative acknowledgement (NACK) protocol to support HARQ operations.

In the UL, a data source 675 is used to provide upper layer packets to the controller/processor 660. The data source 675 represents all protocol layers above the L2 layer. Similar to the functionality described in connection with the DL transmission by the eNB 110, 210, 230, the controller/processor 660 implements the L2 layer for the user plane and the control plane by providing header compression, ciphering, packet segmentation and reordering, and multiplexing between logical and transport channels based, at least in part, on radio resource allocations by the eNB 110, 210, 230. The controller/processor 660 is also responsible for HARQ operations, retransmission of lost packets, and signaling to the eNB 110, 210, 230.

Channel estimates derived by a channel estimator 655 from a reference signal or feedback transmitted by the eNB 110, 210, 230 may be used by the TX processor 680 to select the appropriate coding and modulation schemes, and to facilitate spatial processing. The spatial streams generated by the TX processor 680 are provided to different antenna 645 via separate transmitters TX, for example, of transceivers TX/RX 640. Each transmitter TX, for example, of transceiver TX/RX 640 modulates an RF carrier with a respective spatial stream for transmission.

The UL transmission is processed at the eNB 110, 210, 230 in a manner similar to that described in connection with the receiver function at the UE 145, 250. Each receiver RX, for example, of transceiver TX/RX 625 receives a signal through its respective antenna 620. Each receiver RX, for example, of transceiver TX/RX 625 recovers information modulated onto an RF carrier and provides the information to a RX processor 630. The RX processor 630 may implement the L1 layer.

The controller/processor 605 implements the L2 layer. The controller/processor 605 can be associated with a memory 635 that stores program code and data. The memory 635 may be referred to as a computer-readable medium. In the UL, the control/processor 605 provides demultiplexing between transport and logical channels, packet reassembly, deciphering, header decompression, control signal processing to recover upper layer packets from the UE 145, 250. Upper layer packets from the controller/processor 605 may be provided to the core network. The controller/processor 605 is also responsible for error detection using an ACK and/or NACK protocol to support HARQ operations.

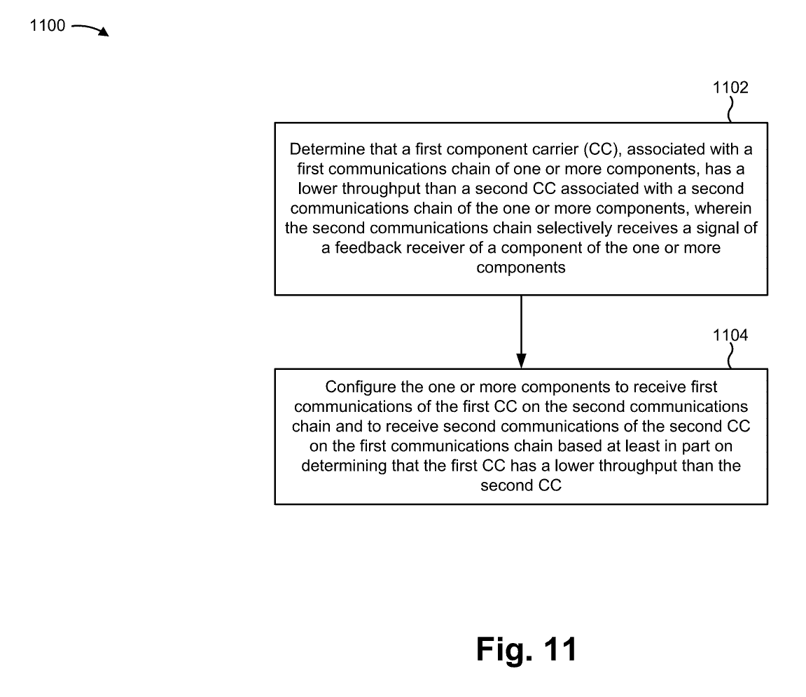

One or more components of UE 145, 250 may be configured to perform configuration of component carriers associated with UE 145, 250 to improve carrier aggregation throughput in a feedback receiver based wireless communication device, as described in more detail elsewhere herein. For example, the controller/processor 660 and/or other processors and modules of UE 145, 250 may perform or direct operations of, for example, process 1100 of FIG. 11, and/or other processes as described herein. In some aspects, one or more of the components shown in FIG. 6 may be employed to perform process 1100 of FIG. 11, and/or other processes for the techniques described herein.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

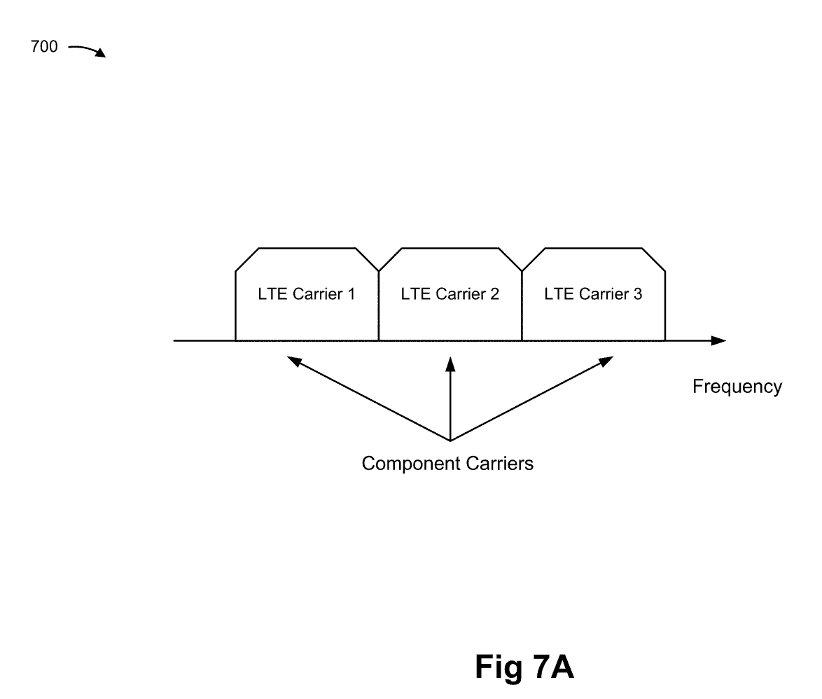

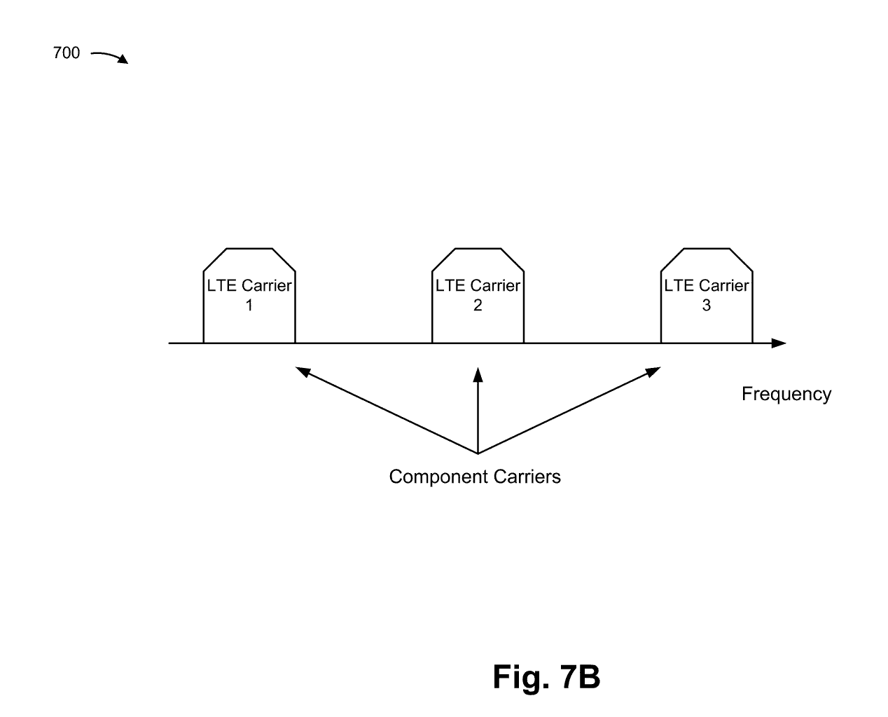

FIGS. 7A and 7B are illustrations of examples 700 of carrier aggregation types, in accordance with various aspects of the present disclosure.

In some aspects, UE 145, 250 may use spectrum of up to 20 MHz bandwidths allocated in a carrier aggregation of up to a total of 100 MHz (e.g., 5 component carriers) used for transmission and reception. For an LTE-Advanced enabled wireless communications system, two types of carrier aggregation (CA) methods may be used, contiguous CA and non-contiguous CA, which are illustrated in FIGS. 7A and 7B, respectively. Contiguous CA occurs when multiple available component carriers are adjacent to each other (e.g., as illustrated in FIG. 7A). On the other hand, non-contiguous CA occurs when multiple non-adjacent available component carriers are separated along the frequency band (e.g., as illustrated in FIG. 7B) and/or are included in different frequency bands.

Both non-contiguous and contiguous CA may aggregate multiple component carriers to serve a single unit of LTE-Advanced UEs 145, 250. In various examples, LTE 145, 250 operating in a multicarrier system (e.g., also referred to as carrier aggregation) is configured to aggregate certain functions of multiple carriers, such as control and feedback functions, on the same carrier, which may be referred to as a primary carrier. The remaining carriers that depend on the primary carrier for support may be referred to as secondary carriers. For example, UE 145, 250 may aggregate control functions such as those provided by the optional dedicated channel (DCH), the nonscheduled grants, a physical uplink control channel (PUCCH), and/or a physical downlink control channel (PDCCH).

As indicated above, FIGS. 7A and 7B are provided as examples. Other examples are possible and may differ from what was described in connection with FIGS. 7A and 7B.

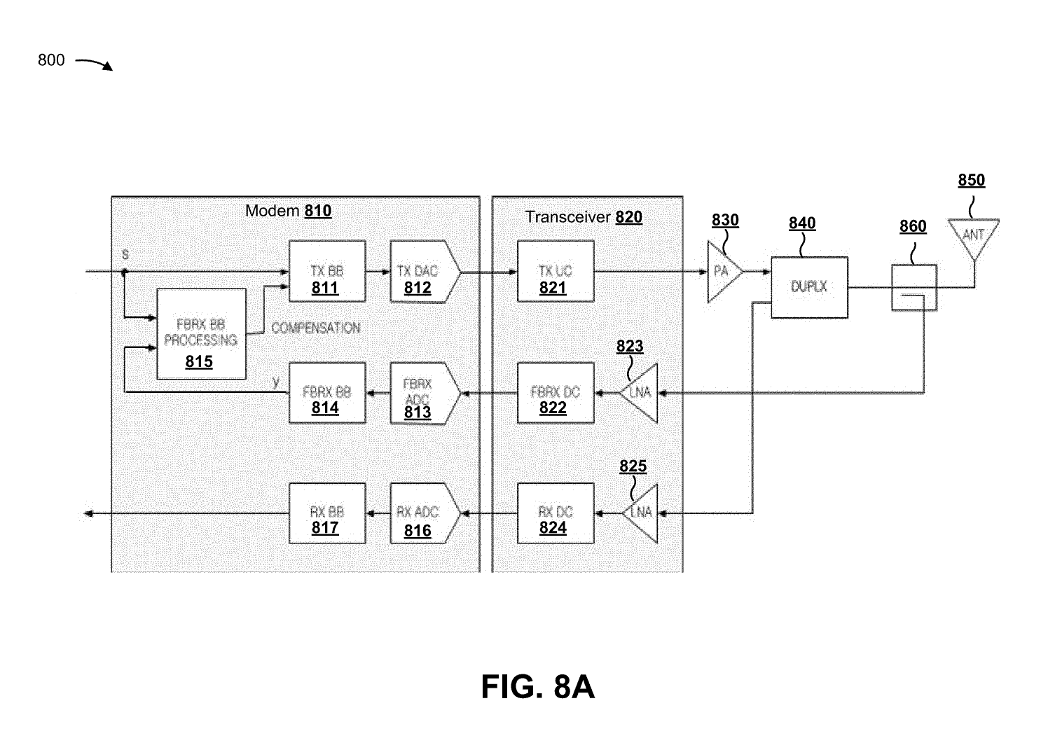

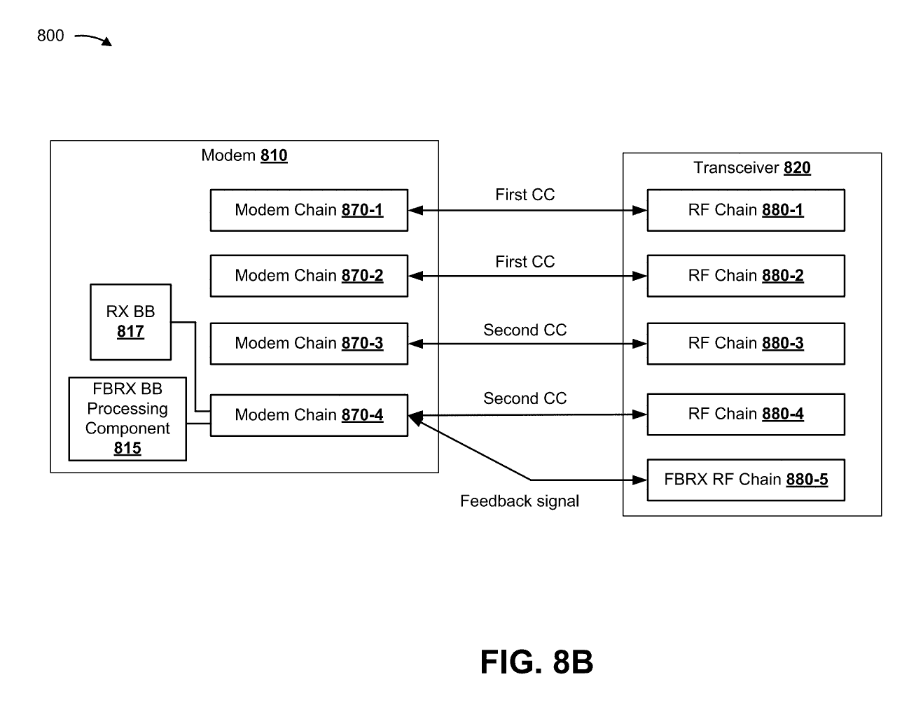

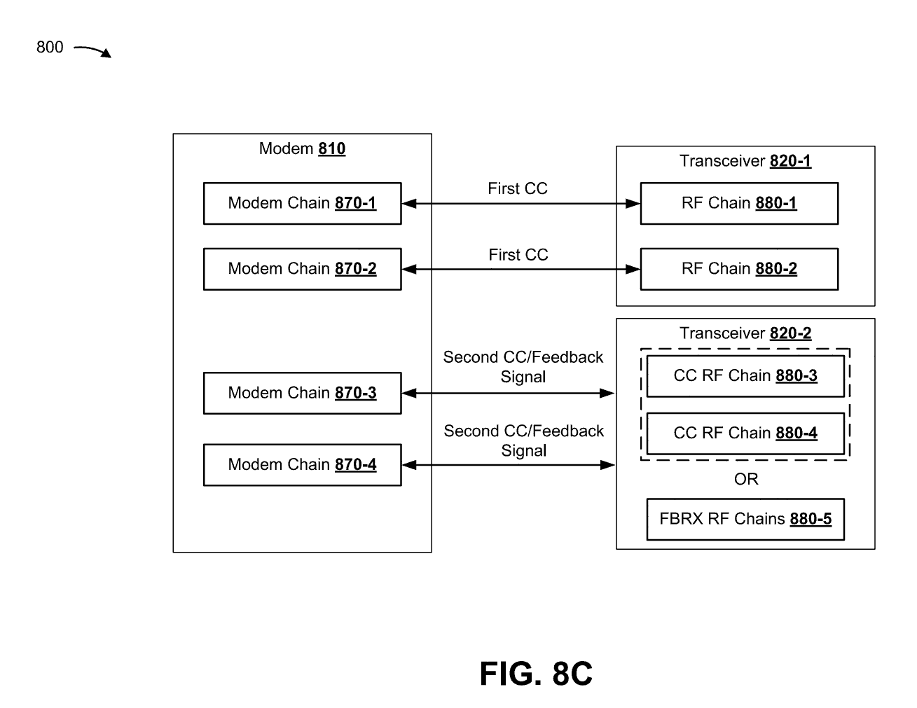

FIG. 8A is a diagram illustrating example components of a wireless communication device. FIGS. 8B-8C are diagrams illustrating example components 800 of communications chains and a feedback receiver (FBRX) of the UE 145, 250, in accordance with various aspects of the present disclosure. As shown in FIG. 8A, UE 145, 250 may include a modem 810, a transceiver 820, a power amplifier (PA) 830, a duplexer 840, an antenna 850, and a feedback component 860.

The modem 810 may include a transmitter baseband processor (TX BB) 811, a transmitter digital-analog converter (DAC) 812, a FBRX analog-digital converter (FBRX ADC) 813, a FBRX baseband interface (FBRX BB) 814, an FBRX BB processing component 815, a receiver ADC 816, and a receiver baseband processor (RX BB) 817.

The TX BB 811 may perform processing operations for a digital transmit signal (e.g., signal processing functions and/or the like). The TX DAC 812 may convert the digital transmit signal to an analog transmit signal to be provided to transceiver 820.

The FBRX ADC 813 may convert an analog feedback signal, received from transceiver 820, into a digital feedback signal. The FBRX BB 814 may receive the digital feedback signal from the FBRX ADC 813, and may perform processing operations on the digital feedback signal (e.g., signal processing operations, sample timing alignment operations, and/or the like). The FBRX BB processing component 815 may receive the processed digital feedback signal, may determine an adjustment with regard to signal strength of the transmit signal, and may provide a compensation signal to the TX BB 811 to configure the TX BB 811 to adjust the signal strength of the transmit signal.

The RX ADC 816 may convert an analog receive signal, received from transceiver 820, into a digital receive signal. The RX BB 817 may receive the digital receive signal from the RX ADC 816, and may perform processing operations for the digital receive signal (e.g., signal processing functions and/or the like).

The transceiver 820 may include one or more transmitter uplink communications chains (TX UC) 821, an optional feedback receiver downlink communications chain (FBRX DC) 822 associated with a low-noise amplifier (LNA) 823, and/or one or more receiver downlink communications chains (RX DC) 824 associated with an LNA 825. The uplink communications chains and downlink communications chains of the transceiver 820 may be referred to herein as communications chains, RF chains, or analog chains.

The TX UC 821 may receive an analog transmit signal from modem 810, and may provide the analog transmit signal to PA 830. The FBRX DC 822 may provide an analog feedback signal to modem 810. The LNA 823 may amplify the analog feedback signal en route to the FBRX DC 822. The analog feedback signal may include at least a portion of the analog transmit signal. For example, the UE 145, 250 may include a feedback component 860 to provide the portion of the analog transmit signal as the analog feedback signal.

The RX DC 824 may receive an analog receive signal from antenna 850, and may provide the analog receive signal to modem 810. The LNA 825 may amplify the analog receive signal en route to the RX DC 824.

The PA 830 may amplify the analog transmit signal en route to antenna 850. The duplexer 840 may multiplex or demultiplex transmitted and received signals associated with antenna 850.

The feedback signal provided by the feedback component 860 may be used by FBRX BB processing component 815 to adjust or compensate transmit power of the UE 145, 250. Thus, UE 145, 250, including the components 800, may be referred to as a feedback receiver based device. In such a device, the modem 810 and transceiver 820 have a dedicated FBRX receive path. Such a configuration is costly.

FIG. 8B shows an example implementation of UE 145, 250 with a dedicated feedback receiver downlink chain in transceiver 820. The modem 810 may be associated with a plurality of communications chains, which are sometimes referred to herein as modem chains. In some aspects, the modem 810 may be associated with four modem chains 870-1 through 870-4. For example, the modem 810 may be associated with a first primary modem chain 870-1 and a first diversity modem chain 870-2, and may be associated with a second primary modem chain 870-3 and a second diversity modem chain 870-4. In such a case, digital receive signals associated with a first component carrier (CC) may be received on the modem chains 870-1 and 870-2, and modem chains 870-1 and 870-2 may be associated with RF chains 880-1 and 880-2, respectively. As further shown, digital receive signals associated with a second CC may be received on modem chains 870-3 (e.g., a primary receive chain) and 870-4 (e.g., a diversity receive chain), and modem chains 870-3 and 870-4 may be associated with RF chains 880-3 and 880-4, respectively. In some aspects, transmit signals may be carried on one or more modem chains (e.g., such as a primary and/or diversity transmit modem chain portions of 870-1 and/or 870-2.

As shown, in some aspects, the feedback signal associated with FBRX RF chain 880-5 may be configured to be received on a particular modem chain 870, such as modem chain 870-4. When the modem chain 870-4 is shared between receiving and/or processing the feedback signal from FBRX RF chain 880-5 and a signal associated with the second CC provided by RF chain 880-4, only one of the feedback signal or a received signal associated with the second CC may be carried by the modem chain 870-4. In such a case, logic in the modem 810 such as RX BB 817, for example, may selectively switch the modem chain 870-4 from a received signal processing component to the FBRX BB processing component 815 to perform feedback receiver operations. This may cause degradation of information associated with the second CC and/or services provided based at least in part on the second CC. In aspects, such degradation may be caused by modem chain 870-4 being used for receiving and/or processing the feedback signal rather than receiving and/or processing a diversity receive signal.

FIG. 8C shows an example implementation of UE 145, 250 wherein transceiver 820 is not associated with a dedicated feedback receiver RF chain. In such a case, UE 145, 250 may include two transceivers 820-1 and 820-2, as an example. The transceiver 820-1 may include RF chains 880-1 and 880-2, which may be coupled to modem chains 870-1 and 870-2, respectively, to provide analog signals associated with a first CC. The transceiver 820-2 may include RF chains 880-3 and 880-4 to provide analog signals associated with a second CC (e.g., shown as CC RF chains 880-3 and 880-4).

As shown, the transceiver 820-2 may be coupled to modem chains 870-3 and 870-4. To provide a feedback signal to modem chains 870-3 and/or 870-4, the transceiver 820-2 may need to be selectively configured from providing a frequency associated with the second CC on CC RF chains 880-3 and 880-4 to processing a feedback signal and transmitting the feedback signal from modem chains 870-3 and/or 870-4. For example, one or more of the primary and diversity RF chains 880-3 and 880-4 may need to be reconfigured to the frequency associated with the feedback signal to be used or serve as FBRX RF chains 880-5 (e.g., based at least in part on a phase-locked loop of transceiver 820-2 being reconfigured to the frequency associated with the feedback signal). This may cause degradation of information associated with the second CC and/or services provided based at least in part on the second CC.

The number and arrangement of components shown in FIGS. 8B-8C are provided as examples. In practice, there may be additional components, fewer components, different components, or differently arranged components than those shown in FIGS. 8A-8C. Furthermore, two or more components shown in FIGS. 8B-8C may be implemented within a single component, or a single component shown in FIGS. 8B-8C may be implemented as multiple, distributed components. Additionally, or alternatively, a set of components (e.g., one or more components) shown in FIGS. 8B-8C may perform one or more functions described as being performed by another set of components shown in FIGS. 8B-8C.

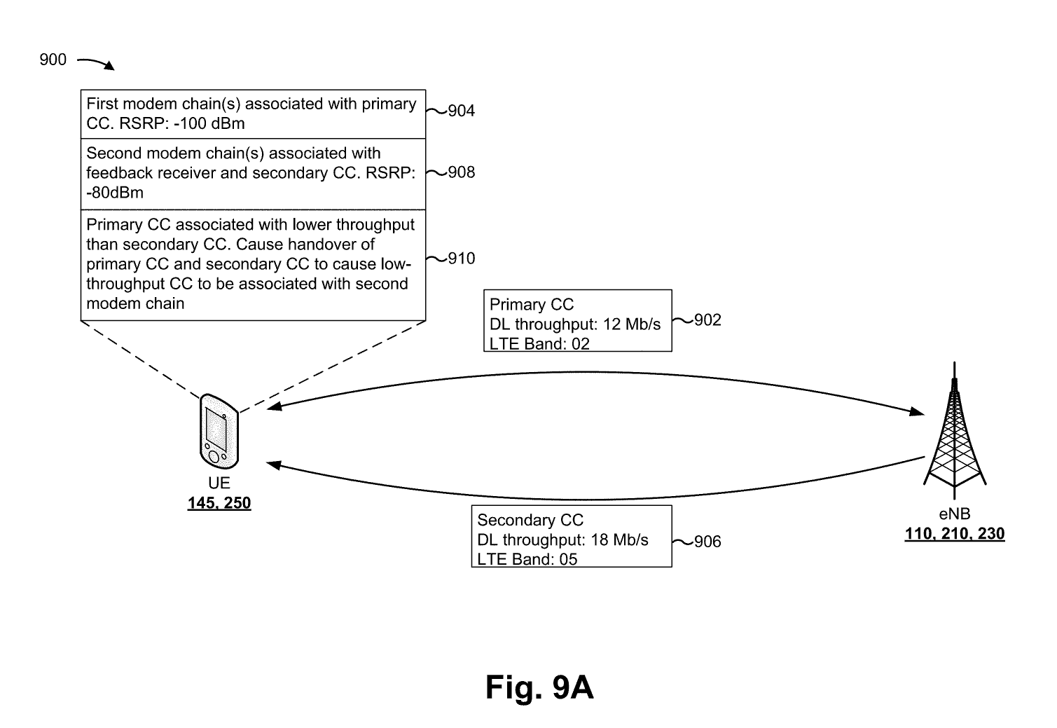

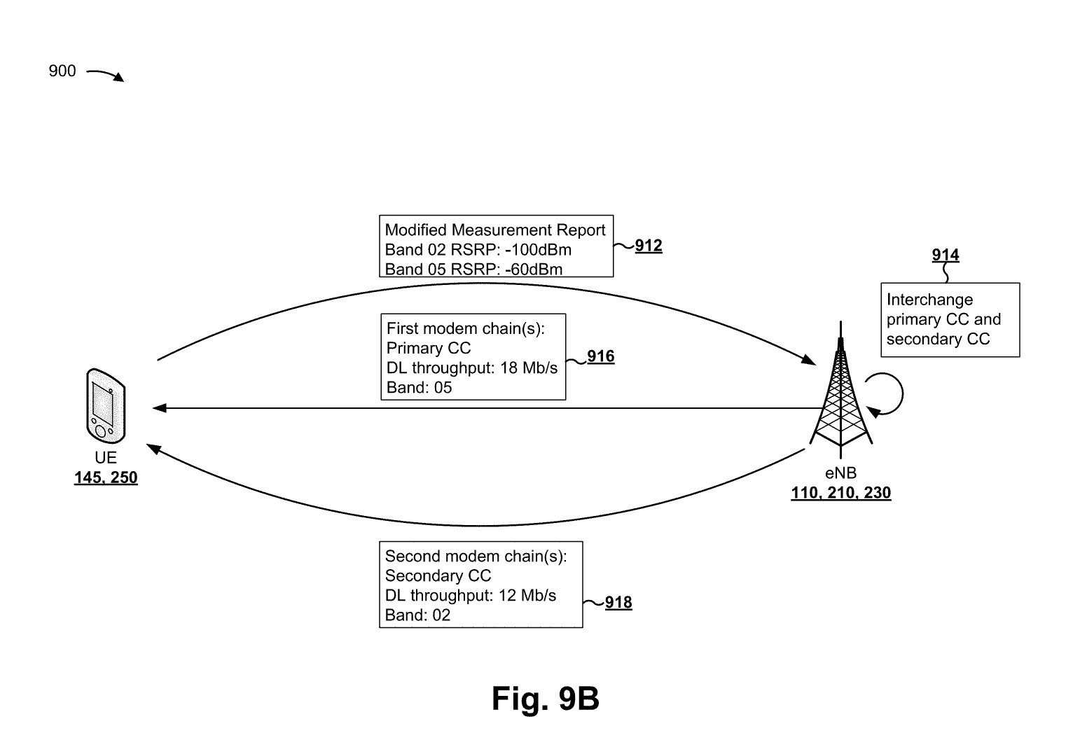

FIGS. 9A and 9B are diagrams illustrating an example 900 of performing configuration of component carriers to improve carrier aggregation throughput in a feedback receiver based wireless communication device, in accordance with various aspects of the present disclosure.

A UE (e.g., UE 145, 250) may perform a feedback receiver function to configure signal transmission strength of the UE. To perform this feedback receiver function, the UE may need to selectively configure one or more communications chains to provide a feedback signal to a feedback baseband processor of the UE. When the one or more modem chains and/or RX chains are shared between the feedback signal and a component carrier (e.g., a secondary CC), information associated with the secondary CC may be degraded. This may negatively impact throughput of the one or more modem chains and/or the one or more RX chains.

Furthermore, in some cases, the secondary CC may be associated with higher throughput than a primary CC that does not share communications chains with the feedback receiver. Thus, when the one or more communications chains are switched from the secondary CC receiving and/or processing to the feedback receiver (thereby interrupting the secondary CC receiving and/or processing), performance is degraded more than if the primary CC receiving and/or processing was interrupted to provide the feedback signal. Implementations described herein perform configuration of the primary CC and the secondary CC such that a lower-throughput CC, of the primary CC and the secondary CC, shares a communications chain with the feedback receiver. Thus, the feedback receiver's impact on overall throughput of the UE is reduced.

As shown in FIG. 9A, and by reference number 902, the UE 145, 250 may be associated with a first component carrier (CC) (e.g., a primary CC). As further shown, the primary CC is associated with a downlink throughput of 12 Mb/s and an LTE band 02 (e.g., band 02 of the LTE spectrum). As shown by reference number 904, one or more first modem chains of UE 145, 250 are associated with the primary CC. For example, a first primary modem chain and/or a first diversity modem chain of the UE 145, 250 may receive communications via the primary CC. As further shown, the UE 145, 250 may determine a channel power measurement for the primary CC (e.g., a reference signal received power (RSRP) of −100 dBm).

As shown by reference number 906, the UE 145, 250 may be associated with a second CC (e.g., a secondary CC). As further shown, the secondary CC is associated with a downlink throughput of 18 Mb/s and LTE band 05 of the LTE spectrum. Here, LTE band 02 and LTE band 05 are specified to improve clarity of the description of FIGS. 9A and 9B. However, implementations described herein are not limited to particular bands or frequencies, and may be implemented with regard to any two or more component carriers, bands, and/or frequencies.

As shown by reference number 908, one or more second modem chains of UE 145, 250 are associated (e.g., selectively associated) with the secondary CC and/or the feedback receiver. For example, a second primary modem chain and/or a second diversity modem chain of the UE 145, 250 may receive communications via the secondary CC, and the second diversity modem chain may receive a feedback signal associated with the feedback receiver. The UE 145, 250 may selectively (e.g., periodically) configure a component of the UE 145, 250 (e.g., a modem) so that the feedback signal is received via the second diversity modem chain to configure or measure transmit power of the UE 145, 250. This may interrupt the secondary CC on the second diversity modem chain. As further shown, the UE 145, 250 may determine a channel power measurement for the secondary CC (e.g., an RSRP of −80 dBm).

While described above as determining an RSRP for the primary CC and/or the secondary CC, in some aspects, the UE 145, 250 may determine another measurement for the primary CC and/or the secondary CC (e.g., a scheduling grant value, a channel quality value, a reference signal received quality (RSRQ) value, a channel quality indicator (CQI), and/or the like).

As shown by reference number 910, the UE 145, 250 may determine that the primary CC is associated with a lower throughput than the secondary CC. For example, the UE 145, 250 may compare the channel power measurement associated with the primary CC and the channel power measurement associated with the secondary CC to determine that the primary CC is associated with a lower throughput than the secondary CC. As further shown, the UE 145, 250 may cause interchange of the primary CC and the secondary CC so that the CC with the lower throughput (e.g., the primary CC associated with LTE band 02) is received on the modem chain associated with the feedback receiver (e.g., the second primary modem chain or the second diversity modem chain). In this way, throughput of UE 145, 250 is increased when performing carrier aggregation in a feedback receiver based UE 145, 250.

As shown in FIG. 9B, and by reference number 912, to cause the interchange, the UE 145, 250 may transmit a modified measurement report. The modified measurement report may identify an RSRP value of the secondary CC that is selected to cause eNB 110, 210, 230 to configure interchange of the primary CC and the secondary CC. Here, UE 145, 250 changes the RSRP value associated with LTE band 05 (e.g., the secondary CC) from −80 dBm to −60 dBm, and changes the RSRP value associated with LTE band 05 from −60 to −100 dBm. This may cause the eNB 110, 210, 230 to configure an interchange of the primary CC and the secondary CC based at least in part on the RSRP value associated with LTE band 05 exceeding the RSRP value associated with LTE band 02 by a threshold amount. As shown by reference number 914, the eNB 110, 210, 230 configures interchange of the primary CC and the secondary CC. In some aspects, the eNB 110, 210, 230 may configure the UE 145, 250 to receive LTE band 05 as the primary CC and to receive LTE band 02 as the secondary CC. For example, the eNB 110, 210, 230 may send a message to the UE 145, 250 to configure the UE 145, 250 to use LTE band 05 as the primary CC and to use LTE band 02 as the secondary CC.

The RSRP values included in the modified measurement report may be different than the RSRP values measured by the UE 145, 250. For example, the UE 145, 250 may transmit RSRP values that are determined based at least in part on the measured RSRP values (e.g., by increasing or decreasing the measured RSRP values by a particular quantity that is known by the UE 145, 250 to cause the eNB 110, 210, 230 to perform the interchange). As another example, the UE 145, 250 may transmit default RSRP values that are configured to cause the interchange.

As shown by reference number 916, after the eNB 110, 210, 230 configures the interchange, LTE band 05 is used as the primary CC by the UE 145, 250, and is received on the one or more first modem chains. As shown by reference number 918, after the eNB 110, 210, 230 configures the interchange, LTE band 02 is used as the secondary CC by the UE 145, 250, and is received on the one or more second modem chains. In this way, the UE 145, 250 configures the high-throughput carrier to be used as the primary carrier, and configures the low-throughput carrier to be used as the secondary carrier. Thus, overall throughput of the carriers is increased by configuring the low-throughput carrier to be interrupted by the feedback receiver associated with the one or more second modem chains, rather than the high-throughput carrier.

As indicated above, FIGS. 9A and 9B are provided as an example. Other examples are possible and may differ from what was described with respect to FIGS. 9A and 9B.

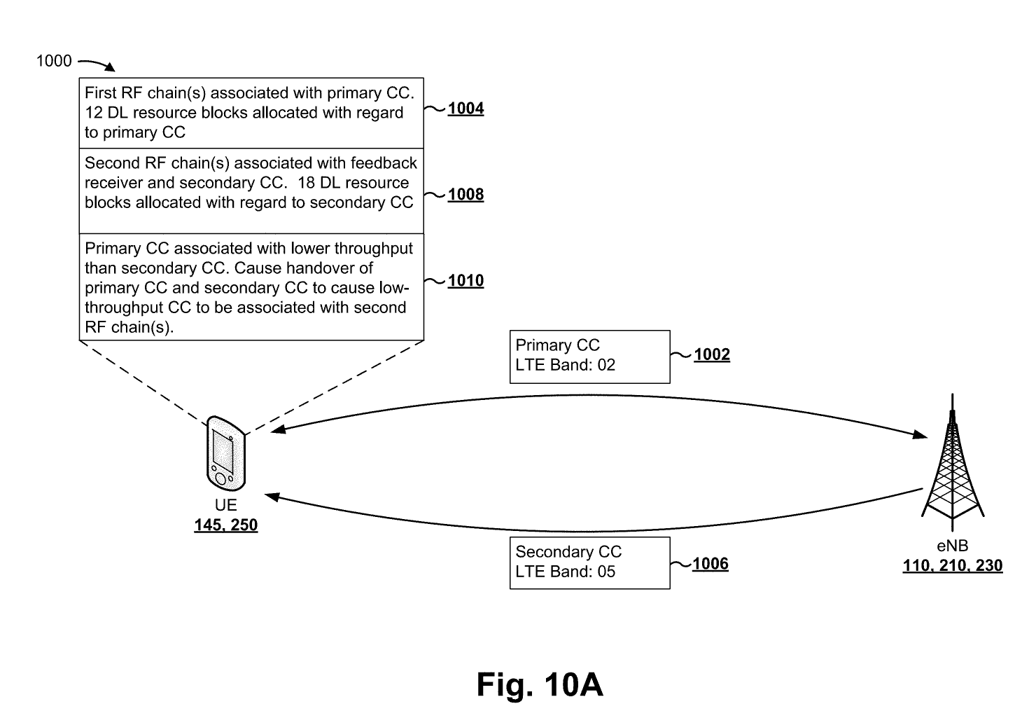

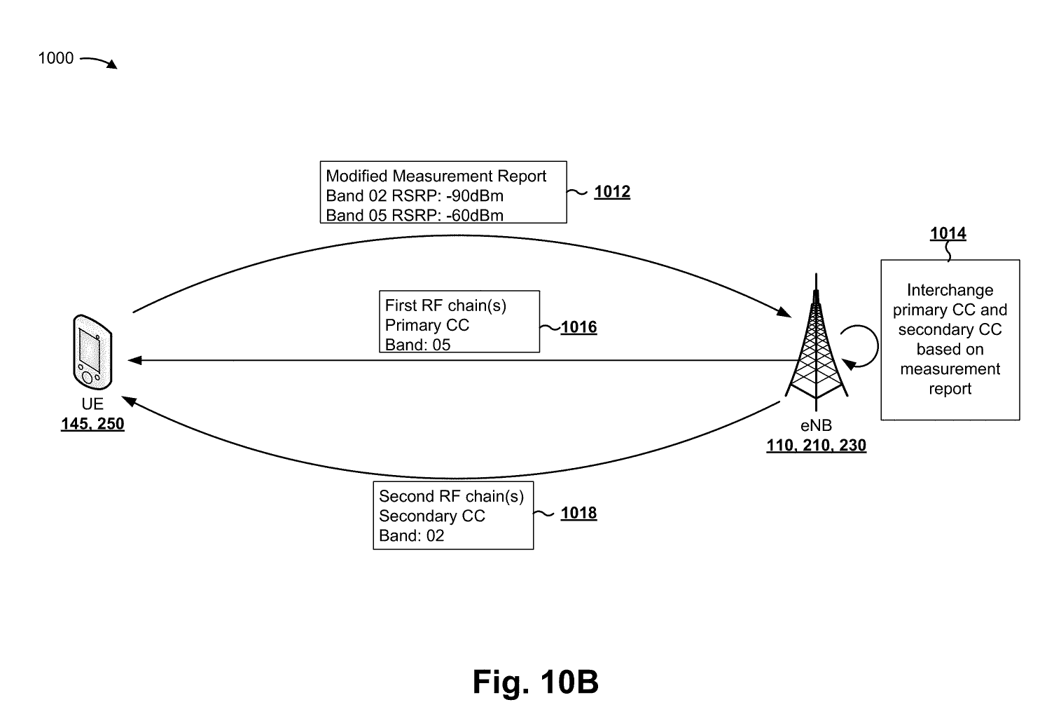

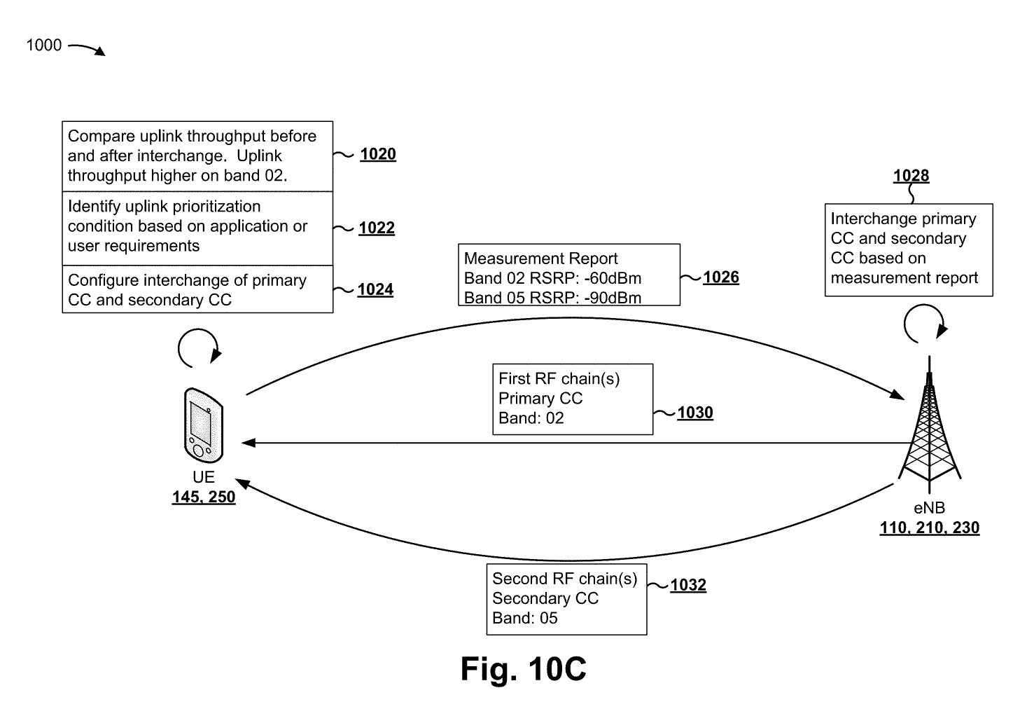

FIGS. 10A-10C are diagrams illustrating another example 1000 of performing configuration of component carriers to improve carrier aggregation throughput in a feedback receiver based wireless communication device, in accordance with various aspects of the present disclosure.

As shown in FIG. 10A, and by reference number 1002, the UE 145, 250 may be associated with a first component carrier (CC) (e.g., a primary CC). As further shown, the first CC is associated with an LTE band of 02 (e.g., LTE band 02 of the LTE spectrum). As shown by reference number 1004, one or more first RF chains of UE 145, 250 are associated with the primary CC. For example, a first primary RF chain and/or a first diversity RF chain of a transceiver of the UE 145, 250 may receive information associated with the primary CC. As further shown, the UE 145, 250 may determine a scheduling grant value for the primary CC (e.g., an allocation of 12 downlink resource blocks for the primary CC). In some aspects, the scheduling grant value may include another value other than an allocation of downlink resource blocks, such as a value identifying a quantity of downlink resource block groups (RBGs) allotted to the primary CC, a value identifying particular downlink resource blocks or RBGs allotted to the primary CC, downlink control information (DCI) associated with the primary CC, and/or the like. The UE 145, 250 may use the scheduling grant value for the primary CC to identify a CC that is associated with a lower throughput, as described in more detail below.

As shown by reference number 1006, the UE 145, 250 may be associated with a second CC (e.g., a secondary CC). As further shown, the secondary CC is associated with an LTE band 05 (e.g., LTE band 05 of the LTE spectrum). As shown by reference number 1008, one or more second RF chains of the UE 145, 250 are associated (e.g., selectively associated) with the secondary CC and/or with a feedback receiver of the UE 145, 250. For example, a second primary RF chain and/or a second diversity RF chain of a transceiver of the UE 145, 250 may receive information associated with the secondary CC. In such an aspect, the second primary RF chain and/or the second diversity RF chain may be selectively (e.g., periodically) configured to provide a feedback signal from the feedback receiver instead of to provide information associated with the secondary CC, as described in more detail in connection with FIG. 8C, above. This may reduce throughput of the one or more second RF chains with regard to the secondary CC.

As further shown, the UE 145, 250 may determine a scheduling grant value for the secondary CC (e.g., an allocation of 18 downlink resource blocks for the secondary CC). In some aspects, the scheduling grant value may include another value, such as a value identifying a quantity of downlink RBGs allotted to the secondary CC, a value identifying particular downlink resource blocks or RBGs allotted to the secondary CC, DCI associated with the secondary CC, and/or the like.

As shown by reference number 1010, the UE 145, 250 may determine that the primary CC (associated with LTE band 02) is associated with a lower throughput than the secondary CC (associated with LTE band 05). For example, the UE 145, 250 may determine that the primary CC is associated with a lower throughput than the secondary CC based at least in part on comparing the scheduling grant value for the primary CC (e.g., 12 downlink resource blocks) to the scheduling grant value for the secondary CC (e.g., 18 downlink resource blocks). In some aspects, the UE 145, 250 may determine that the primary CC is associated with a lower throughput than the secondary CC based at least in part on another value (e.g., an RSRP value, an RSRQ value, a CQI, and/or the like).

As further shown, the UE 145, 250 may configure interchange of the primary CC and the secondary CC so that the CC with the lower throughput (e.g., the CC associated with LTE band 02) is received on the transceiver chains associated with the feedback receiver (e.g., the second transceiver chains).

As shown in FIG. 10B, and by reference number 1012, to cause the interchange, the UE 145, 250 may transmit a modified measurement report. The modified measurement report may identify an RSRP value of the secondary CC that is selected to cause interchange of the primary CC and the secondary CC. Here, UE 145, 250 indicates, in the measurement report, an RSRP value of −60 dBm for band 05 (e.g., the secondary CC), which is selected by the UE 145, 250 to trigger interchange of the primary CC and the secondary CC. As shown by reference number 1014, the eNB 110, 210, 230 configures interchange of the primary CC and the secondary CC based at least in part on the modified measurement report.

As shown by reference number 1016, after the eNB 110, 210, 230 configures the interchange, LTE band 05 is used as the primary CC by the UE 145, 250, and is received on the one or more first RF chains. As shown by reference number 1018, after the eNB 110, 210, 230 configures the interchange, LTE band 02 is used as the secondary CC by the UE 145, 250, and is received on the one or more second RF chains (e.g., the RF chain(s) associated with the feedback receiver). For example, the eNB 110, 210, 230 may transmit a message to the UE 145, 250 to cause the UE 145, 250 to use LTE band 05 as the primary CC and LTE band 02 as the secondary CC. In this way, the UE 145, 250 configures the high-throughput carrier to be received on the first RF chains, and configures the low-throughput carrier to be received on the second RF chains. Thus, overall throughput of the carriers is increased by configuring the low-throughput carrier to be interrupted by the feedback receiver.

FIG. 10C shows an example of configuring a component carrier of UE 145, 250 to improve uplink throughput in a feedback receiver based wireless communication device, in accordance with various aspects of the present disclosure. For example, LTE band 02 and LTE band 05 may provide different uplink throughputs for data transmitted by the UE 145, 250. In some cases, uplink throughput may be more important than downlink throughput for the UE 145, 250. For example, a particular application may require high uplink throughput. As another example, a particular user interaction may cause a data upload process, which may require high uplink throughput. FIG. 10C shows an example of comparing an uplink throughput before the interchange described in connection with FIG. 10B, and an uplink throughput after the interchange, to determine which LTE band is associated with a higher uplink throughput. FIG. 10C further describes detecting an uplink prioritization condition (e.g., a condition for which uplink throughput is to be prioritized over downlink throughput), and selectively configuring an interchange of the primary CC and the secondary CC so that an LTE band with a higher uplink throughput is used as the primary CC (e.g., the CC that is used to transmit uplink data). In this way, uplink throughput of the UE 145, 250 is improved when an uplink prioritization condition is identified.

As shown by reference number 1020, the UE 145, 250 may compare uplink throughput before and after the interchange described in connection with FIG. 10B to determine that uplink throughput is higher on LTE band 02 than on LTE band 05. For example, the UE 145, 250 may determine uplink performance information for LTE band 02 when LTE band 02 is associated with the primary CC (e.g., before the interchange), may determine uplink performance information for LTE band 05 when LTE band 05 is associated with the primary CC (e.g., after the interchange), and may compare the uplink performance information to determine that uplink throughput is higher on LTE band 02 than on LTE band 05. The uplink performance information may include, for example, an uplink bandwidth value, retransmission information associated with the uplink, scheduling information associated with the uplink, and/or the like.

As shown by reference number 1022, the UE 145, 250 may identify an uplink prioritization condition based at least in part on an application requirement or a user requirement. For example, the UE 145, 250 may identify an uplink prioritization condition based at least in part on a QoS requirement associated with uplink traffic, information provided by a user, channel conditions associated with the uplink, an amount of data to be provided via the uplink, the uplink traffic being associated with a particular application, and/or the like.

As shown by reference number 1024, the UE 145, 250 may configure interchange of the primary CC (e.g., the CC associated with LTE band 05, configured in connection with FIG. 10B) and the secondary CC (e.g., the CC associated with LTE band 02). The UE 145, 250 may configure the interchange to cause the CC associated with a higher uplink throughput to be used as the primary CC based at least in part on the uplink prioritization condition. This may cause the CC associated with the lower uplink throughput to be received on the one or more communications chains (e.g., the modem chains and/or the RF chains) associated with the feedback receiver, thereby reducing uplink throughput impact of the feedback receiver and increasing uplink throughput.

As shown by reference number 1026, to configure the interchange, the UE 145, 250 may transmit a modified measurement report. The modified measurement report may be modified to increase an RSRP value of the secondary CC (e.g., the CC associated with LTE band 02) to a value that may cause eNB 110, 210, 230 to configure interchange of the primary CC and the secondary CC so that LTE band 02 is associated with the primary CC. Here, UE 145, 250 configures the modified measurement message to identify a RSRP value of LTE band 02 as −60 dBm. As shown by reference number 1028, the eNB 110, 210, 230 interchanges the primary CC and the secondary CC based on the modified measurement report. In some aspects, the eNB 110, 210, 230 may transmit a message to the UE 145, 250 to cause the UE 145, 250 to use LTE band 02 as the primary CC and LTE band 05 as the secondary CC.

As shown by reference number 1030, after the eNB 110, 210, 230 configures the interchange, LTE band 02 is used as the primary CC by the UE 145, 250, and is associated with the one or more first RF chains. As shown by reference number 1032, after the eNB 110, 210, 230 configures the interchange, LTE band 05 is used as the secondary CC by the UE 145, 250, and is associated with the one or more second RF chains. In this way, the UE 145, 250 configures the CC associated with high uplink throughput to be used as the primary CC based at least in part on an uplink prioritization condition, and configures the CC associated with low uplink throughput to be used as the secondary CC on the communications chains associated with the feedback receiver. Thus, overall throughput of the carriers is increased by causing the low-uplink-throughput carrier to be interrupted by the feedback receiver, rather than the high-uplink-throughput carrier. Furthermore, the UE 145, 250 can selectively configure interchange of the primary CC and the secondary CC based on whether uplink throughput or downlink throughput is to be prioritized, thereby reducing network traffic congestion and improving throughput of the feedback receiver based UE 145, 250.

While FIG. 10C is described in connection with first RF chains and second RF chains of the UE 145, 250, the operations of FIG. 10C are equally applicable with regard to first modem chains and second modem chains of the UE 145, 250.

As indicated above, FIGS. 10A-10C are provided as an example. Other examples are possible and may differ from what was described with respect to FIGS. 10A-10C.

FIG. 11 is a diagram illustrating an example process 1100 performed, for example, by a wireless communication device, in accordance with various aspects of the present disclosure. Example process 1100 is an example where a wireless communication device (e.g., UE 145, 250) performs configuration of a first CC and a second CC such that a CC with a lower throughput is associated with a communications chain that is associated with a FBRX.

As shown in FIG. 11, in some aspects, process 1100 may include determining that a first component carrier (CC), associated with a first communications chain of one or more components of a wireless communication device, has a lower throughput than a second CC associated with a second communications chain of the one or more components, wherein the second communications chain selectively receives a signal of a feedback receiver of a component of the one or more components (block 1102). For example, a UE 145, 250 may determine that a first CC, associated with a first communications chain of one or more components of the UE 145, 250, has a lower throughput than a second CC associated with a second communications chain of the one or more components of the UE 145, 250. The second communications chain may selectively (e.g., periodically) receive a signal of a feedback receiver of a component, of the one or more components, of the UE 145, 250.

In some aspects, the first communications chain may include a first primary communications chain and a first diversity communications chain. In some aspects, the second communications chain may include a second primary communications chain and a second diversity communications chain, wherein the second diversity communications chain selectively receives the signal of the feedback receiver.

In some aspects, the first communications chain may be associated with a primary CC and the second communications chain may be associated with a secondary CC.

In some aspects, the UE 145, 250 may determine that the first CC has a lower throughput than the second CC based at least in part on determining that the first CC is associated with a lower scheduling grant value than the second CC.

In some aspects, the UE 145, 250 may determine that the first CC has a lower throughput than the second CC based at least in part on determining that the first CC is associated with a lower channel power measurement than the second CC.

In some aspects, the UE 145, 250 may determine that the first CC has a lower throughput than the second CC based at least in part on determining that the first CC is associated with a lower channel quality value than the second CC.

In some aspects, the first communications chain may include a first primary modem chain and a first diversity modem chain, and the second communications chain may include a second primary modem chain and a second diversity modem chain.

In some aspects, the one or more components of the UE 145, 250 may include a modem.

In some aspects, the first communications chain may include a first primary RF chain and a first diversity RF chain, and the second communications chain may include a second primary RF chain and a second diversity RF chain.

In some aspects, the one or more components of the UE 145, 250 may include at least one transceiver.

As shown in FIG. 11, in some aspects, process 1100 may include configuring the one or more components to receive first communications of the first CC on the second communications chain and to receive second communications of the second CC on the first communications chain based at least in part on determining that the first CC has a lower throughput than the second CC (block 1104). For example, the UE 145, 250 may configure the one or more components of the UE 145, 250 to receive first communications of the first CC on the second communications chain and to receive second communications of the second CC on the first communications chain based at least in part on determining that the first CC has a lower throughput than the second CC.

In some aspects, the UE 145, 250 may configure the one or more components to receive first communications of the first CC on the second communications chain and to receive second communications of the second CC on the first communications chain by modifying one or more measurement reports to be transmitted to a base station (e.g., eNB 110, base station 130, eNB 210, eNB 230).

In some aspects, the UE 145, 250 may determine, before the one or more components are configured to receive the first communications on the second communications chain, that the first CC is associated with a first uplink throughput on the first communications chain. In some aspects, the UE 145, 250 may determine, after the one or more components are configured to receive the first communications on the second communications chain, that the second CC is associated with a second uplink throughput on the first communications chain. In some aspects, the UE 145, 250 may configure one of the first CC or the second CC as a primary CC based at least in part on the first uplink throughput and the second uplink throughput.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based at least in part on” is intended to mean “based, at least in part, on” unless explicitly stated otherwise.

What is claimed is:

1. A method of wireless communication for one or more components of a wireless communication device, comprising:
determining that a first component carrier (CC), associated with a first communications chain of the one or more components of the wireless communication device, has a lower throughput than a second CC associated with a second communications chain of the one or more components of the wireless communication device,
wherein the second communications chain selectively receives a signal of a feedback receiver of a component of the one or more components of the wireless communication device; and
configuring the one or more components of the wireless communication device to receive first communications of the first CC on the second communications chain and to receive second communications of the second CC on the first communications chain based at least in part on determining that the first CC has a lower throughput than the second CC.

2. The method of claim 1, wherein configuring the one or more components of the wireless communication device comprises:
modifying one or more measurement reports to be transmitted to a base station.

3. The method of claim 1, wherein the first communications chain comprises a first primary communications chain and a first diversity communications chain; and
wherein the second communications chain comprises a second primary communications chain and a second diversity communications chain,
wherein the second diversity communications chain selectively receives the signal of the feedback receiver.

4. The method of claim 1, wherein the first communications chain is associated with a primary CC and the second communications chain is associated with a secondary CC.

5. The method of claim 1, wherein determining that the first CC has a lower throughput than the second CC comprises:
determining that the first CC is associated with a lower scheduling grant value than the second CC.

6. The method of claim 1, wherein determining that the first CC has a lower throughput than the second CC comprises:
determining that the first CC is associated with a lower channel power measurement than the second CC.

7. The method of claim 1, wherein determining that the first CC has a lower throughput than the second CC comprises:
determining that the first CC is associated with a lower channel quality value than the second CC.

8. The method of claim 1, wherein:
the first communications chain comprises a first primary modem chain and a first diversity modem chain; and
the second communications chain comprises a second primary modem chain and a second diversity modem chain.

9. The method of claim 8, wherein the one or more components of the wireless communication device include a modem.

10. The method of claim 1, wherein:
the first communications chain comprises a first primary radio frequency (RF) chain and a first diversity RF chain; and
the second communications chain comprises a second primary RF chain and a second diversity RF chain.

11. The method of claim 10, wherein the one or more components of the wireless communication device includes at least one transceiver.

12. The method of claim 1, further comprising:
determining, before the one or more components are configured to receive the first communications on the second communications chain, that the first CC is associated with a first uplink throughput on the first communications chain; and
determining, after the one or more components are configured to receive the first communications on the second communications chain, that the second CC is associated with a second uplink throughput on the first communications chain; and
configuring one of the first CC or the second CC as a primary CC based at least in part on the first uplink throughput and the second uplink throughput.

13. A wireless communication device, comprising:
a memory;
one or more components; and
one or more processors, operatively coupled to the memory, the one or more processors configured to:
determine that a first component carrier (CC), associated with a first communications chain of the one or more components of the wireless communication device, has a lower throughput than a second CC associated with a second communications chain of the one or more components of the wireless communication device,
wherein the second communications chain selectively receives a signal of a feedback receiver of a component of the one or more components of the wireless communication device; and
configure the one or more components of the wireless communication device to receive first communications of the first CC on the second communications chain and to receive second communications of the second CC on the first communications chain based at least in part on determining that the first CC has a lower throughput than the second CC.

14. The wireless communication device of claim 13, wherein the one or more processors, when configuring the one or more components of the wireless communication device, are configured to:
modify one or more measurement reports to be transmitted to a base station.

15. The wireless communication device of claim 13, wherein:
the first communications chain comprises a first primary modem chain and a first diversity modem chain; and
the second communications chain comprises a second primary modem chain and a second diversity modem chain.

16. The wireless communication device of claim 15, wherein the one or more components of the wireless communication device include a modem.

17. The wireless communication device of claim 13, wherein:
the first communications chain comprises a first primary radio frequency (RF) chain and a first diversity RF chain; and
the second communications chain comprises a second primary RF chain and a second diversity RF chain.

18. The wireless communication device of claim 17, wherein the one or more components of the wireless communication device include at least one transceiver.

19. An apparatus for wireless communication, comprising:
means for determining that a first component carrier (CC), associated with a first communications chain of one or more components of the apparatus, has a lower throughput than a second CC associated with a second communications chain of the one or more components of the apparatus,
wherein the second communications chain selectively receives a signal of a feedback receiver of a component of the one or more components of the apparatus; and
means for configuring the one or more components of the apparatus to receive first communications of the first CC on the second communications chain and to receive second communications of the second CC on the first communications chain based at least in part on determining that the first CC has a lower throughput than the second CC.

20. The apparatus of claim 19, wherein the first communications chain comprises a first primary communications chain and a first diversity communications chain; and
wherein the second communications chain comprises a second primary communications chain and a second diversity communications chain,
wherein the second diversity communications chain selectively receives the signal of the feedback receiver.
